(19) United States
(12) Patent Application Publication
(10) Pub. No.: US 2007/0248283 A1
(43) Pub. Date: Oct. 25, 2007

(54) Method and apparatus for a wide area virtual scene preview system

(76) Inventors: Newton Eliot Mack, Somerville, MA (US); Anna D. Callahan, Somerville, MA (US)

Correspondence Address: David D. Lowry, Esq.;Brown Rudnick Berlack Israels LLP, One Financial Center, Boston, MA, 02111, US

(21) Appl. No.: 11/409,305

(22) Filed: Apr. 21, 2006

(51) Int. Cl. G06K 9/36; G06K 9/32; G09G 5/00

(52) U.S. Cl. 382/284; 382/294; 345/629

(57) ABSTRACT

The present invention provides a cost effective, reliable system for producing a virtual scene combining live video enhanced by other imagery, including computer generated imagery. In one embodiment it includes a scene camera with an attached tracking camera, the tracking camera viewing a tracking marker pattern, which has a plurality of tracking markers with identifying indicia. The tracking marker pattern is positioned proximate so that when viewed by the tracking camera, the coordinate position of the scene camera can be determined in real time. The present invention also includes novel filtering algorithms, that vary based on camera motion and maintain accurate positioning.

### FIELD OF INVENTION

The present invention relates to image production, more specifically, to a virtual scene previewing system with 3D spatial positioning.

### BACKGROUND OF THE INVENTION

Virtual Set technology has been used in broadcasting and graphic design applications for years. Feature films, television shows and video games utilize a virtual world to visually enhance the viewers' experience. For example, one of the most common and well-known applications of virtual set technology is a weather broadcast on a local or national news network. To a viewer at home, the scene portrays a broadcaster standing next to or in front of a screen with an image on it, typically a map or satellite photo. This is a virtual set. In reality the broadcaster is standing in front of what is generally referred to as a “Blue Screen”. The blue screen, usually a retro-reflective material, is blank to anyone looking directly at it in the studio. The image of the weather map or satellite photo is generated and superimposed by a computer onto the imagery that is transmitted across the television airwaves using a process known in the art as traveling matte or keying. The broadcaster uses a television off to the side of the set to reference his movements or gestures against the map. The map is added in a real-time algorithm that alters the image from the live camera into the composite image that is seen on television.

Virtual set technology has expanded greatly in recent years leading to entire television programs and countless numbers of feature film scenes being filmed with the aid of composite images superimposed into the recorded video. The use of computer generated imagery (“CGI”) has allowed film makers and directors to expand the normal conventions of scenery and background imagery in their productions. Powerful computers with extensive graphics processors generate vivid, high-definition images that cannot be recreated by hand, or duplicated by paint. The use of CGI reduces the number of background sets needed to film a production. Rather than have several painted or constructed background scenes, computer generated images can serve as backdrops reducing the space and cost required to build traditional sets.

In the arena of video games, movies, and television, virtual set technology is used to create backgrounds, model, and record character movement. The recorded movements are then overlaid with computer graphics to makes the video game representation of the movement more true to life. In the past, to create character movement for a video game, complex mathematical algorithms were created to model the movement of the character. Because the character movement model was never completely accurate, the character's movement appeared choppy and awkward. With the advent of virtual set technology, a “library” of movements can be recorded live and superimposed onto the characters in post-production processing. Video games with unique characters and unique character movements, such as football or baseball simulation games, benefit from such technology. The technology makes the game appear much more realistic to the player.

The increased capability of employing virtual set technology, however, does come with the added cost of powerful and complex graphics processors, or engines, as well as specialized equipment and background screens. On a set in which the cameras are moving, the computers must track the location of the camera at all times in relation to the screen to properly create a realistic scene. Many existing systems require the use of a special background with embedded markers that enable the computer to calculate the camera's position in the virtual scene by using a marker detection method. These markers can interfere with the keying process, which typically performs best with a seamless background of the same color. Further, such markers can cause interference when a character blocks one or more markers. Also, the computer may not be able to calculate the camera's position if the character blocks one or more markers.

Other existing systems utilize a second camera, called a tracking camera affixed to the first camera, or scene camera. The tracking camera references the location of tracking markers fixed to the ceiling to calculate the location of the camera in the scene. Because the tracking camera is mounted to the scene camera, both move together through the set and can be located along a coordinate grid. These systems require the tracking camera to see several markers at once to provide an accurate position estimation. Identifying and calculating on several markers is complex, time-consuming and error-prone.

### SUMMARY OF THE INVENTION

Virtual scene previewing systems expand the capabilities of producing video. Virtual scene systems allow a producer to import three-dimensional texture mapped models and high resolution two-dimensional digital photographs and mix them with live video. Use of modern techniques from the world of visual effects like camera projection mapping and matte painting provide for even more flexibility in the creation of a video production. Enabling free motion of the scene camera increases creative freedom for the director or cinematographer.

Various embodiments of a wide are virtual scene previewing system are provided. In one embodiment, a scene camera records the image of a subject in front of a background. The scene camera is connected to a computer or recorder by a data cable or wireless data link. A tracking camera facing upwards is mounted to the scene camera, and is also connected to a computer, either the either the same computer or another computer on a network, by a data cable. Overhead is a pattern of optical markers that can be seen by the tracking camera, which captures an image of one or more markers. The markers are affixed to an overhead panel in this embodiment. The images of the tracking marker are also sent to a computer, which calculates the scene camera's position based on the position of the markers overhead. If the scene camera moves during recording, the tracking camera will process its location by the tracking marker motion and the images provided by the computer can be adjusted accordingly. In addition, a tilt and roll sensor may be added to the scene camera, to improve motion capture on these axes.

The computer, using a three-dimensional graphics engine, will superimpose a computer-generated image or images into the live recording image from the camera. The graphics engine processes the location of the scene camera in combination with the data of the computer generated image to adjust for factors such as proper depth, field of view, position, resolution, and orientation. The adjusted virtual images or background are combined with the live recording to form a composite layered scene of live action and computer generated graphics.

An embodiment of the present invention includes an image capturing system comprising a scene camera viewing a first image within a defined space, and a tracking marker pattern including a plurality of tracking markers with identifying indicia, the tracking marker pattern positioned proximate the defined space, but positioned outside a view of the scene camera. A tracking camera is coupled to the scene camera, the tracking camera oriented to view at least a portion of the tracking marker pattern; wherein the tracking camera captures a view of at least one of the tracking markers. A processor is in communication the tracking camera, the processor receiving the captured view of at least one of the tracking markers from the tracking camera, the processor processing the captured view to determine a coordinate position of the scene camera, by identifying in the captured view at least one of the tracking markers by the identifying indicia, and determining the coordinate position of the scene camera relative to the at least one identified tracking marker. A feature of this embodiment includes that only one of the tracking markers in the captured view is needed to determine the coordinate position of the scene camera.

The processor may apply filtering algorithms to the captured view of at least one of the tracking markers. Different filtering algorithms may be used when it is determined that the scene camera is in motion. As an example, the processor may apply an aggressive filtering algorithm when it is determined that the scene camera is stationary. A less aggressive filtering algorithm is used when it is determined that the scene camera is in motion. If the scene camera is accelerating, the processor may apply an even less aggressive filtering algorithm.

An embodiment of the present invention also includes an orientation sensor, coupled to the scene camera. The orientation sensor determine an orientation of the scene camera; wherein the orientation sensor is in communication with the processor, to provide orientation data to the processor.

The present invention also includes a method of tracking a position of a scene camera, comprising attaching a tracking camera to the scene camera, the tracking camera oriented to view at least a portion a tracking marker pattern, the tracking marker pattern including a plurality of tracking markers with identifying indicia; capturing an image of at least one of the tracking markers with the tracking camera; and processing the captured image to identify the at least one tracking marker by the identifying indicia; and to determine a coordinate position of the scene camera relative to the at least one identified tracking marker. The method may include applying filtering algorithms to the captured image. Different filtering algorithms may be applies upon determining that the scene camera is in motion or accelerating.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 depicts a perspective view of a studio with a scene camera positioned to photograph a subject in front of a background in accordance with an embodiment of the present invention;

FIG. 2 depicts an example of the tracking target pattern according to one embodiment;

FIG. 3 depicts a block diagram describing data flow between parts of the system according to one embodiment;

FIG. 4A depicts a subject layer of a composite image seen from a scene camera in one embodiment of the present invention;

FIG. 4B depicts virtual objects to be combined with the subject layer of FIG. 4A; and

FIG. 4C depicts a composite proxy image, from combining the subject and virtual layers of FIGS. 4A and 4B respectively.

### DETAILED DESCRIPTION

The present invention provides a cost effective, reliable system for producing a virtual scene combining live video enhanced by other imagery, including computer generated imagery. The present invention provides a seamless environment expanding the capabilities of virtual video production. Applications ranging from video games to feature films can implement the system for a fraction of the cost of traditional virtual sets. The system greatly reduces the costly and complex computer processing time required in existing systems. The present invention also eliminates the need for specialized materials used in the backgrounds of virtual sets, and enables smooth tracking of camera moves typically used in motion picture and television photography.

A similar system is described in co-owned U.S. patent application Ser. No. 11/260,810 filed on Oct. 27, 2005 and incorporated herein by reference.

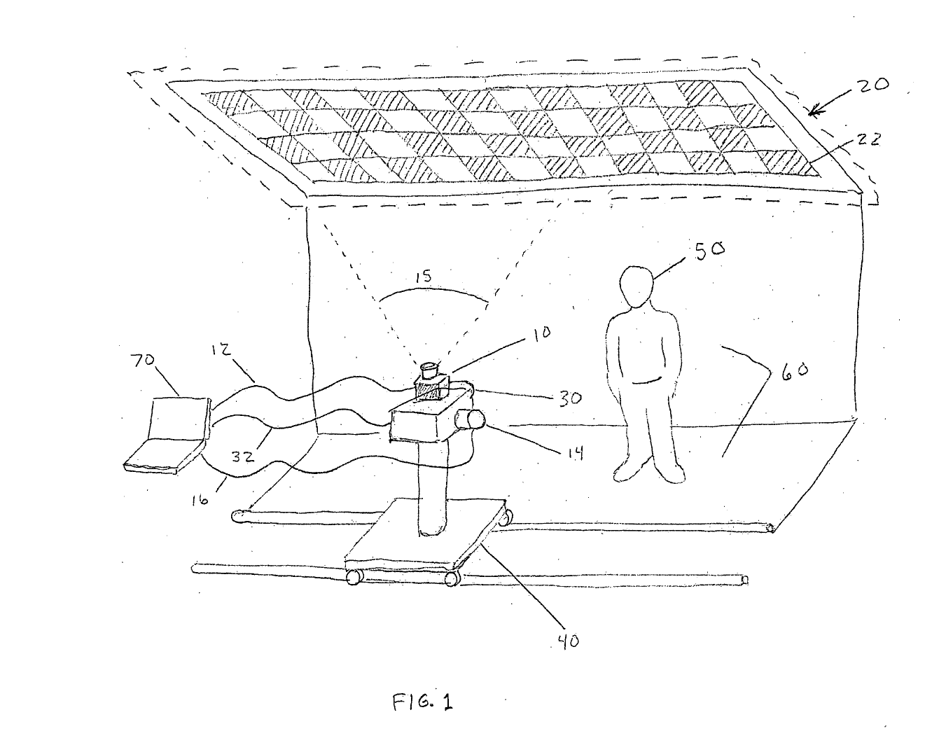

An embodiment of the present invention is illustrated in FIG. 1. A scene camera 30 is positioned to capture an image of a subject 50 in front of a background 60. The scene camera 30 is typically mounted on a camera support 40. This camera support 40 may be in the form of a tripod, dolly, handheld, stabilized, or any other form of camera support in common use. There may be more than one scene camera 30 in order to capture different views of the subject's performance. The scene camera 30 is connected to a computer 70 by a scene camera data cable 32. A tracking camera 10 is attached to the scene camera 30 and oriented so that some or all of a tracking marker pattern 20 is within its field of view 15. A tilt and roll sensor 14 is optionally attached to the scene camera 30. A data cable 16 connects the tilt and roll sensor 14 to the computer 70. The computer 70 may be positioned near the scene camera 30 so that the camera operator and/or the director can see the system output.

The tracking marker pattern 20 in one embodiment is a flat panel with a printed pattern facing downward. The printed pattern consists of several individual tracking markers 22. The tracking marker pattern 20, of this embodiment is advantageous as it easily portable and can be installed quickly in a variety of studio locations. The tracking camera 10 is connected to the computer 70 by a tracking camera data cable 12. The tracking camera 10 and scene camera 30 may also be connected to separate computers 70 that communicate with each other through a network (wired or wireless).

Although the present embodiment depicted describes a data cable as the means of connecting the cameras to the processors, one skilled in the art should recognize that any form of data transmission can be implemented without deviating from the scope of the invention.

The tracking camera 10 is used to collect images of the tracking marker pattern 20. The image quality required for tracking the tracking marker 10 is lower than the image quality generally required for the scene camera 30, enabling the use of a lower cost tracking camera 10. In one embodiment, the tracking camera 10 is a simple electronic camera with a fixed field of view 15. Since the tracking camera 10 is not focused upon the scene, the tracking performance is independent of the exact contents and lighting of the subjects 50 in the scene. In the preferred embodiment, the tracking camera is a Dragonfly2 camera, made by Point Grey Research Inc. of Vancouver, BC, Canada. This independence extends to the background 60. As mentioned before, some existing systems require the use of a special background to enable the scene camera's position to be derived from the images it produces. The present implementation of a separate tracking camera 10, as shown in the present embodiment, eliminates the need for special background materials and complex set preparation.

In one existing system in the prior art, the position and orientation of the scene camera is determined by seeing a similar pattern of markers mounted overhead. These systems operate by recognizing each marker overhead. The individual marker patterns are known to the tracking system. In addition, the original position of each individual marker in the pattern is known to the tracking system. The system is able to determine the distance from the tracking camera to each marker, but is not able to determine the orientation of an individual marker with respect to the camera. Because of this, the system requires at least 5 markers can be seen at once, to resolve the position and orientation unknowns of the scene camera.

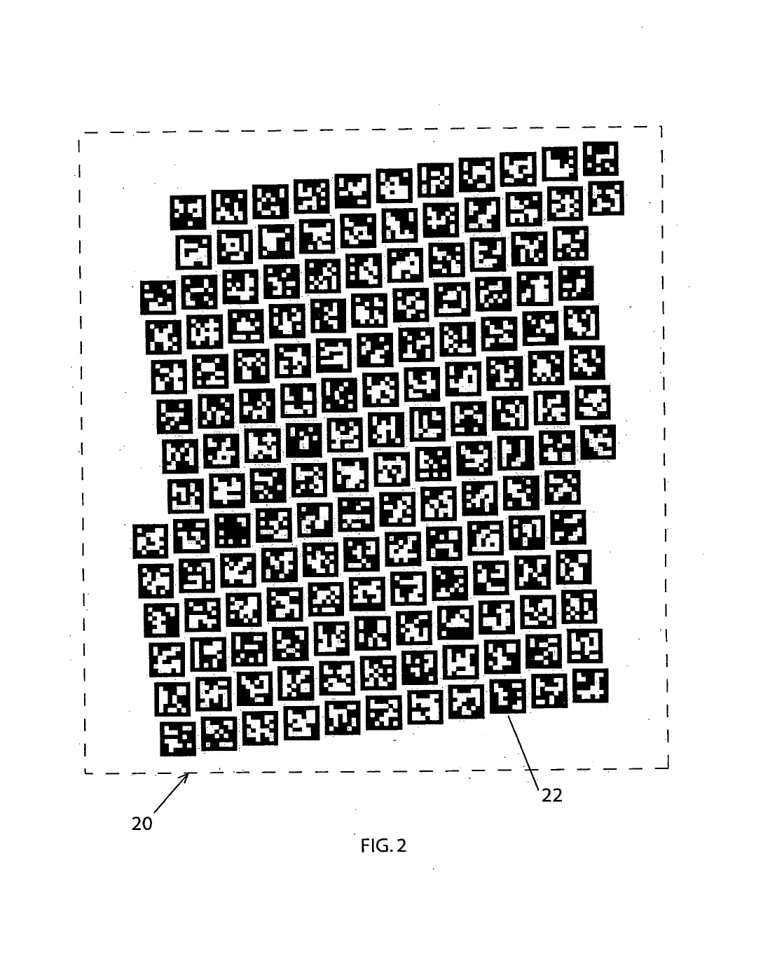

In an illustrative embodiment, the tracking marker pattern 20 FIG. 2 is composed of a set of binary coded markers 22. These markers 22 are described in the National Research Council of Canada in NRC Publication number 47419, “A Fiducial Marker System Using Digital Techniques”, 2004, by Dr. Mark Fiala. These markers 22, in combination with marker position and detection software libraries, make it possible to determine the relative position of tracking camera 10 to any individual identified tracking marker 22, as well as to the overall tracking marker pattern 20. In the illustrative embodiment, these marker position and detection libraries are the ARToolkit/ARToolkitPlus libraries, described in ‘Marker Tracking and HMD Calibration for a Video-based Augmented Reality Conferencing System”, 1999, by Hirokazu Kato and Mark Billinghurst. The relative position of the tracking camera 10 can then be derived from the ARToolkit positional matrix with the algorithm described in Appendix A. These markers 22 and the ARToolkit library enable the relative position and orientation of tracking camera 10 to the tracking marker pattern 20 with a single marker 22; this lowers the number of required visible markers by a factor of 5 over previously systems, and enables improvements in required computer processing power, system installation difficulty, and system accuracy.

The existing prior art embodiment of the tracking marker patterns as used in the ARTag/ARToolkit implementations causes several problems when used for camera tracking purposes. Most motion picture camera work is done using a track, dolly, or similar device that smooths out the motion of the camera to avoid visual stutters in the scene camera's image. A sudden jump in the result of the data that tracking camera 10 produces will create a very visible mismatch between the smoothly moving live action foreground and the virtual background. Since the default embodiments of the tracking marker pattern arrangements used in ARToolkit and ARTag are rectangular arrays of markers 22, the tracking data undergoes a large jump when one line of markers goes out of view of the tracking camera 10 and another line of markers comes into view all at once. To prevent this, the illustrative embodiment of the tracking marker pattern uses a staggered pattern, with each marker slightly offset from its neighbors both horizontally and vertically. In this way, during a typical scene camera motion along a track, the markers 22 that are visible to tracking camera 10 do not simultaneously enter or exit the field of view. Alternative embodiments could include a randomly distributed array of markers, and markers of various sizes and orientations.

In addition, the size of the individual tracking markers 22 in tracking marker pattern 20 becomes important to prevent sudden large jumps in the position and orientation data derived from their visibility to tracking camera 10. A larger marker provides more accurate tracking data, as the increased size provides the algorithms used in ARToolkit with more accurate data to derive relative position and orientation with. However, too large a marker means that fewer patterns are visible to tracking camera 10 at any given time. Since the relative position of the tracking camera 10 and the tracking marker pattern 20 is determined by averaging the relative positions of the individually visible tracking markers in the pattern, it is typically advantageous to have a large number of patterns visible in the tracking camera's 10 field of view that can be reliably recognized and tracked. This number, in the illustrative embodiment, is about sixteen markers per square foot.

The raw data collected from tracking camera 10 includes much noise; this typically should be filtered without hampering the real time performance. Typical industry standard filters for noise removal include low pass filters; but these introduce a severe time lag in the output, which is unacceptable for the immediate feedback desired in a virtual set system. The illustrative embodiment uses a derivative based filter, as detailed in Appendix B. The basic function of the filter is to use two separate levels of noise filtration, depending upon whether the scene camera 10 is stationary, or in the process of moving. Typical motion picture camera moves begin with a stationary camera, then accelerate to a more or less constant speed, and then decelerate to end with a stationary camera. While the scene camera 10 is stationary, the filter should remove noise very aggressively, as any spurious motion of the virtual background is very apparent when the foreground image is stationary. However, as soon as the camera 10 begins to move, the filter should instantly follow the motion of the scene camera 10; otherwise, the virtual background will be seen to ‘lag’ behind the live action foreground. The threshold is determined by an acceleration level limit; if the acceleration is exceeded, the filter calculates the existing rate of speed, and heavily filters incoming data values that diverge from the expected speed by a large amount. This can be reasonably expected to be filter noise, as camera moves are rarely extremely jerky.

This filter typically stores the twenty most recent position and orientation data points. For each new point entering the filter, the derivative of the past few data points is calculated, and used to predict where the new point should be, plus or minus an adjustable margin. If the new data point lies outside these margins, it is considered to be an error in the signal, and the new data point is placed halfway between the two extreme margins. These altered past data points are used to determine the slope of the line in the next round of computation. The filter then treats each of three states differently in three cases:
1) If the slope is extremely small, the filter weights the expected data point heavily; the new raw data point is weighted less and less as the slope approaches zero.
2) If the difference between the current slope and the previous slope is high, the filter weights the new raw data point double the weight of the expected data point.
3) For all other cases, the filter weights the new raw data point and the expected data point equally.

The tracking marker pattern 20 in this illustrative embodiment is a downward facing flat panel with a printed black and white pattern of markers applied. The tracking marker pattern 20 is advantageous as it requires no power cables, and is easily portable, enabling its use in portable situations frequently found in motion picture and television production. Further, the tracking marker pattern 20 is easily and inexpensively scalable in that markers 22 can be easily added or removed in order to cover more or less area, or arranged along certain areas where camera movement is planned.

The ARToolkit and ARTag libraries as used by the illustrative embodiment attempt to use tracking marker pattern 20 to determine all six degrees of freedom of the relative positions between a tracking camera and the marker pattern. This works well in many cases, such as the augmented reality applications that the ARToolkit library was originally designed for. However, in the production of motion pictures, the typical scene camera tilt motion, combined with the preferred overhead orientation of tracking marker pattern 20, provides poor tilt data due to the relatively flat orientations of the markers with respect to tracking camera 10. Since the tilt data is computed from the relative parallax of the markers, when they are viewed head on extracting tilt data is not always easily possible. To resolve this flaw, the illustrative embodiment adds an additional tilt sensor 30 FIG. 1 to the system. This tilt sensor 30 is connected to the computer 70 using a data cable 16. This data cable 16, in the illustrative embodiment is a RS232 serial cable. The tilt sensor 30 may use a variety of technologies typically used in industry to measure the tilt of a body, either in reference to an established orientation, or in relation to another body. In addition, it is preferable to also track the rolling motion of the camera; this type of motion is less common in scene camera moves, but is still needed to provide a complete solution. In the illustrative embodiment, orientation sensor 30 is a 3DM tilt and orientation module made by the Microstrain corporation of Williston, Vt., which uses an array of magnetometers and accelerometers to generate stable orientation data, including both tilt and roll. An alternative embodiment is to use the data from the same orientation sensor 30 to provide panning information; this potentially provides pan position information that is not subject to the periodic ‘jumps’ in sensor output that occur when an tracking marker 20 enters or exits the field of view 15 of tracking camera 10.

In addition to studio use, the present invention can be used at a physical set or location; this is advantageous if the background 60 were to be composed of a combination of physical objects and computer generated objects.

Although the present embodiments depicted illustrate the use of one scene camera 30, one skilled in the art should recognize that any number of scene cameras to accommodate multiple views, and multiple viewpoints can be implemented without deviating from the scope of the invention.

Further, while the present embodiments depicted show the use of a single, flat, overhead tracking pattern, one skilled in the art should recognize that the tracking pattern can be shaped in multiple ways to accommodate the needs of working in a particular studio configuration.

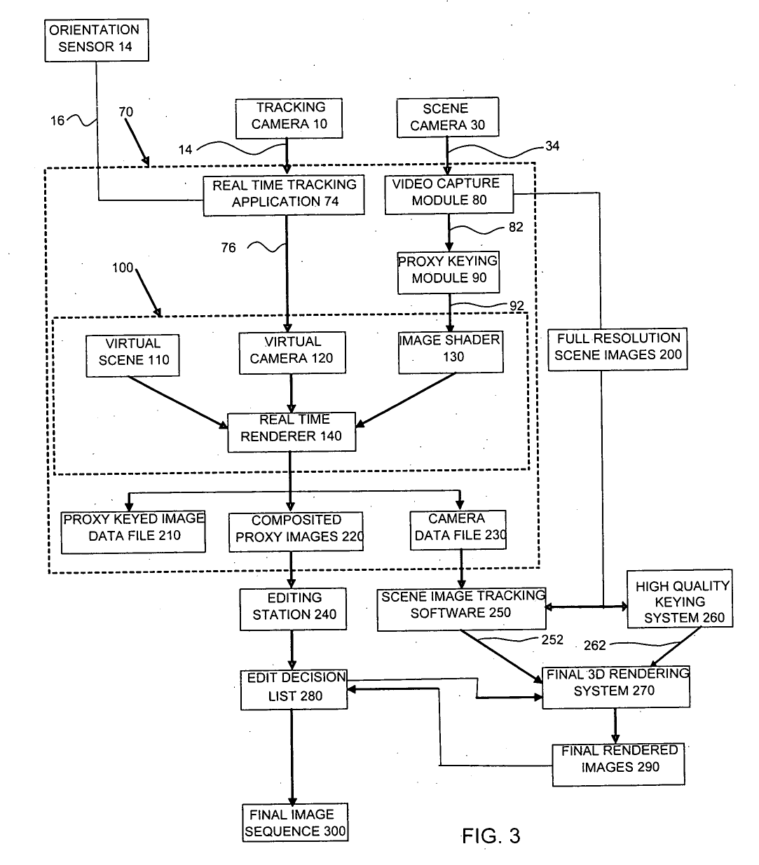

Turning now to FIG. 3, the data flow 310 during operation of the system is shown in accordance with an embodiment of the present invention. The tracking camera 10 sends tracking image data 14 to a real-time tracking application 74 running on computer 70. In the illustrative embodiment, the tracking image data 14 can be simply represented by a buffer containing luminance data for each pixel. Each component running on computer 70 may optionally be run on a separate computer to improve computation speed. In one embodiment all of the components run on the same computer 70. A real-time tracking application 74 filters and processes the tracking image data 14 to generate proxy camera coordinate data 76 for a virtual camera 120 operating within a real-time three-dimensional engine 100. The proxy camera coordinate data 76 consists of camera position and orientation data transmitted as a string of floating point numbers in the form (posX posY posZ rotX rotY rotZ).

The scene camera 30 sends record image data 34 of the subject 50's performance to a video capture module 80 running on the computer 70, or a separate computer or image recording device. This video capture module 80 generates proxy image data 82 which is sent to a proxy keying module 90. The proxy image data 82 is generated in the standard computer graphics format of an RGB buffer, typically containing but not limited to twenty-four bytes for each pixel of red, green, and blue data (typically eight bytes each.) The proxy image data 82 includes not only visual information of the scene's contents, but also information describing the precise instant the image was captured. This is a standard data form known in the art as timecode. This timecode information is passed forward through the system along with the visual information. The timecode is used later to link the proxy images to full resolution scene images 200, also generated by the scene camera 30, as well as final rendered images 290.

The proxy keying module 90 generates proxy keyed image data 92 which is then sent to an image plane shader 130 operating within the real-time three-dimensional engine 100. The real-time three-dimensional engine 100 also contains a virtual scene 110 which contains the information needed to create the background image for the composite scene. The real-time three-dimensional engine 100 is of a type well known in the industry and used to generate two-dimensional representations of three-dimensional scenes at a high rate of speed. This technology is commonly found in video game and content creation software applications. While the term “real-time” is commonly used to describe three-dimensional engines capable of generating two-dimensional representations of complex three-dimensional scenes at least twenty-four frames per second, the term as used herein is not limited to this interpretation.

The real-time tracking application 74 processes the tracking image data 14 to generate the proxy camera coordinate data 76 using a set of algorithms implemented in the ARToolkit/ARToolkitPlus software library, an image processing library commonly used in the scientific community. The software library returns a set of coordinates of the target pattern in a 3×4 transformation matrix called patt_trans. The positional and rotational data is extracted from the 3×4 patt_trans matrix with a set of algorithms which convert the data in the patt_trans matrix into the more useful posX, posY, posZ, rotX, rotY, and rotZ components. An example of source code to perform this conversion is shown in Appendix A.

The use of standard references, or fiducial markers, as tracking markers 20 has many advantages. Since the markers are of a known size and shape, and as the tracking camera 10 can be a standardized model, the calibration of the tracking camera 10 to the tracking marker pattern 20 can be calculated very accurately and standardized at the factory. This enables the use of the system in the field on a variety of scene cameras 30 and support platforms without needing to recalibrate the system. The two components that do the measuring work only need to be calibrated once before delivery. The fiducial marker calibration data can be calculated using standard routines available in the ARToolkit library. The tracking camera calibration data can likewise be generated using these standard routines, and included in a file with the rest of the system. Since the calibration data is based on the focal length and inherent distortions in the lens, the calibration data does not change over time. In addition, the tilt sensor 30 determines its relative orientation with respect to gravitational forces, and hence does not require any local calibration.

The real-time three-dimensional engine 100 uses the proxy camera coordinates 76 to position the virtual camera 120 and the image shader 130 within the virtual scene 110. The image shader 130, containing the proxy keyed image data 92, is applied to planar geometry 132. The planar geometry 132 is contained within the real-time three-dimensional engine 100 along with the virtual scene 110. The planar geometry 132 is typically located directly in front of the virtual camera 120 and perpendicular to the orientation of the virtual camera's 120 lens axis. This is done so that the virtual scene 110 and the proxy keyed image data 92 line up properly, and give an accurate representation of the completed scene. The code sample, provided in Appendix A provides the proper conversions to generate the position and orientation format needed by the engine: centimeters for X, Y, and Z positions, and degrees for X, Y, and Z rotations. When the scene camera 30 is moved, the virtual camera 120 inside the real-time three dimensional engine 100 sees both the virtual scene 120 and the proxy keyed image data 92 in matched position and orientations, and produces composited proxy images 220.

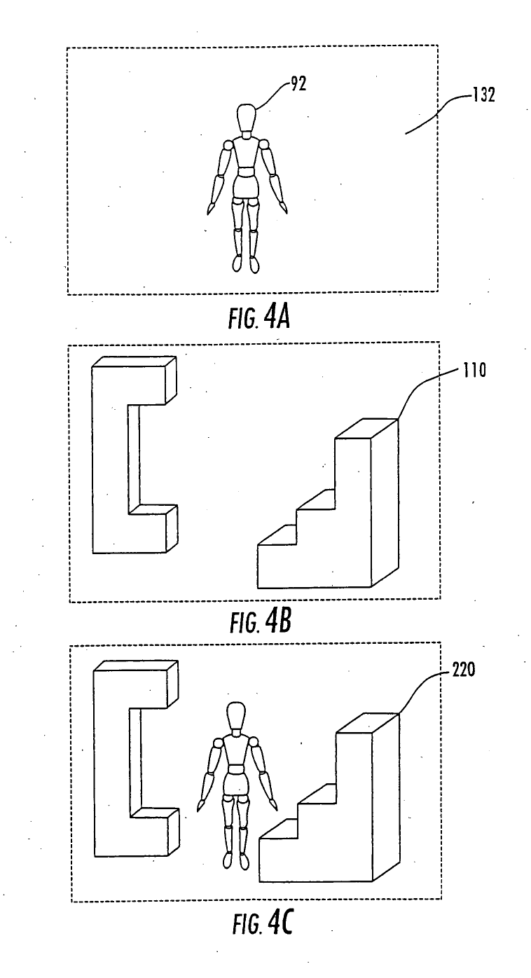

The image combination, according to one embodiment is shown in FIGS. 4A, 4B, and 4C. The planar geometry 132 may be located at an adjustable distance from the virtual camera 120; this distance may be manually or automatically adjustable. This allows the proxy keyed image data 92 to appear in front of or behind objects in the virtual scene 110 for increased image composition flexibility. As the planar geometry 132 moves closer to the virtual camera 120, its size must be decreased to prevent the proxy keyed image data 92 from being displayed at an inaccurate size. This size adjustment may be manual or automatic. In the present embodiment this adjustment is automatically calculated based upon the field of view of the virtual camera 120 and the distance from the planar geometry 132 to the virtual camera 120.

The design of the real-time three-dimensional engines 100 is well established within the art and has been long used for video games and other systems requiring a high degree of interactivity. In one embodiment, the real-time three-dimensional engine is used to generate the composited proxy images 220. As an additional embodiment, the real-time three-dimensional engine 100 may also produce the final rendered images 290 given the proper graphics processing and computer speed to narrow or eliminate the quality difference between real-time processing and non real-time processing.

The proxy image sequence may also be displayed as it is created to enable the director and the director of photography to make artistic decisions of the scene camera 30 and the subject 50's placement within the scene. In one embodiment, the proxy image sequence is displayed near the scene camera 30, allowing the camera operator or director to see how the scene will appear as the scene camera 30 is moved.

In addition to composited proxy image sequence 220, the real-time three-dimensional engine 100 also produces a camera data file 230 and a proxy keyed image data file 210. These files collect the information from the proxy camera coordinate data 76 and the proxy keyed image data 92 for a single take of the subject's 50 performance. These may be saved for later use. In an embodiment of the present invention, a second virtual camera can be created within the virtual scene 110 that moves independently from the original virtual camera 120. The original virtual camera 120 moves according to the proxy camera coordinate data 76, and the planar geometry 132 containing the proxy keyed image data 92 moves with the original virtual camera 120. In this manner, a second virtual camera move, slightly different from the original virtual camera 120 move, can be generated. If the second camera moves very far away from the axis of the original virtual camera 120, the proxy keyed image data 92 will appear distorted as it will be viewed from an angle instead of perpendicular to the plane it is displayed on. A second virtual camera, however, can be used to create a number of dramatic camera motions. The final versions of the camera data and scene image data can also be used to create this effect.

To create a final composite set image, the precise scene camera 30 location and orientation data must be known. A camera data file 230, which contains the collected data set of the proxy camera coordinate data 76, will sometimes not be sufficiently accurate for final versions of the composite image. It can be used, however, as a starting point for the scene tracking software 250. The scene image tracking software 250 uses the full resolution scene images 200 to calculate the precise scene camera 30 location and orientation for each take of the subject's 50 performance, using inter-frame variation in the images. This type of software is well known and commercially available in the visual effects industry; examples include Boujou by 2d3, Ltd., of Lake Forest, Calif. and MatchMover by Realviz, S. A, of San Francisco, Calif. The level of accuracy of this type of software is very high, but requires significant computer processing time per frame and as such may not be useful for the real-time calculation of the proxy camera coordinate data 76. The scene image tracking software 250 is used to generate final camera coordinate data 252 which is then imported into a final three-dimensional rendering system 270. This three-dimensional rendering system 270 generates the final high quality versions of the background scene. The background information is very similar to that found in virtual scene 110 but with increased levels of detail necessary to achieve higher degrees of realism.

In one embodiment of the present system, the final camera coordinate data 252 drives a motion control camera taking pictures of a physical set or a miniature model; this photography generates the final background image which is then composited together with final keyed scene data 262.

The full resolution scene images 200 are also generated from the scene camera 30 using a video capture module 80. This can be the same module used to generate the proxy scene image data 82 or a separate module optimized for high quality image capture. This can also take the form of videotape, film, or digitally based storage of the original scene images. The present embodiment uses the same video capture module 80.

The full resolution scene images 200 are then used by both the scene image tracker software 250 and the high quality keying system 260. The scene image tracker software 250, as previously mentioned, generates the final camera coordinate data 252 by implementing the image processing applications, mentioned above, on the scene image. The high quality keying system 260 creates the final keyed scene images 262 through a variety of methods known in the industry, including various forms of keying or rotoscoping. These final keyed scene images can then be used by the final three dimensional rendering system 270 to generate final rendered images 290. Alternatively, the final keyed scene images can be combined with the final rendered images 290 using a variety of compositing tools and methods well known within the industry. Common industry tools include Apple Shake, Discreet Combustion, and Adobe After Effects; any of these tools contain the required image compositing mathematics. The most common mathematical transform for combining two images is the OVER transform; this is represented by the following equation, where Colora is the foreground value of the R, G, and B channels, and Colorb is the background value of the same. Alphaa is the value of the alpha channel of the foreground image; this is used to control the blending between the two images.
Colorₒᵤₜₚᵤₜ=Colorₐ+Color_{b}×(1−Alphaₐ)

The composite proxy images 220 may then brought into an editing station 240 for use by editors, who select which performance or take of the subject 50 they wish to use for the final product. The set of decisions of which take to be used, and the location and number of images within that take needed for the final product, are then saved in a data form known in the industry as an edit decision list 280. The composited proxy image 220 is linked to the matching full resolution scene image 200 using the previously mentioned timecode, which adds data to each image describing the exact moment that it was captured. The edit decision list 280 is initially used by the final three-dimensional rendering system 270 to select which background frames to be rendered, as this is an extremely computationally expensive process and needs to be minimized whenever possible. The edit decision list 280, however, will change throughout the course of the project, so industry practice is to render several frames both before and after the actual frames requested in a take by the edit decision list. The final rendered images 290 can then be assembled into a final output sequence 300 using the updated edit decision list 280 without having to recreate the final rendered images 290.

In addition to the description of specific, non-limited examples of embodiments of the invention provided herein, it should be appreciated that the invention can be implemented in numerous other applications involving the different configurations of video-processing equipment. Although the invention is described hereinbefore with respect to illustrative embodiments thereof, it will be appreciated that the foregoing and various other changes, omissions and additions in the form and detail thereof may be made without departing from the spirit and scope of the invention.

### Appendix A

double sinPitch, cosPitch, sinRoll, cosRoll, sinYaw, cosYaw;

double EPSILON = .00000000001;
float PI = 3.14159;
sinPitch = −patt_trans[2][0];
cosPitch = sqrt(1 − sinPitch*sinPitch);
if ( abs(cosPitch) > EPSILON )
{

sinRoll = patt_trans[2][1] / cosPitch;
cosRoll = patt_trans[2][2] / cosPitch;
sinYaw = patt_trans[1][0] / cosPitch;
cosYaw = patt_trans[0][0] / cosPitch;
}
else
{
sinRoll = −patt_trans[1][2];
cosRoll = patt_trans[1][1];
sinYaw = 0;
cosYaw = 1;
}

// Rotation data
float tempRot = atan2(sinYaw, cosYaw) * 180/PI;
camRaw.rotY = −(180 − abs(tempRot))* (tempRot/abs(tempRot));
tempRot = atan2(sinRoll, cosRoll) * 180 / PI;
camRaw.rotX = (180 − abs(tempRot))* (tempRot/abs(tempRot));
camRaw.rotZ = atan2(sinPitch, cosPitch) * 180 / PI;
// Position data
camRaw.posX = patt_trans[1][3];
camRaw.posY = −patt_trans[2][3];

camRaw.posZ = patt_trans[0][3];

### Appendix B

/* Derivative based noise filtration */
/* rawData[ ] contains last raw data values */
/* altData[ ] contains last filtered data values */
double newAltData = 0;

| m1 = m; | // previous slope value |
|---|---|
| double sp = 0.015; | // sp is positional slope tuning factor; |
| | // determines whether camera is at rest |
| | or moving |
| double weight = 0.6667; | // weighting factor for filter smoothing |
| double accel = 0.12; | // acceleration |
| double window = 0.3; | // determines allowable distance from |
| | existing slope |

double a, b, c, d;
a = rawData[0];
b = rawData[8];
m = (a − b)/8;

| double n = abs(m); | // absolute value of slope over last 8 |
|---|---|
| | data points |

a = altData[1];
b = newRawData;
c = (altData[1] + m − window);
d = (altData[1] + m + window);
if ( (−sp < m) && (m < sp) ) {// if slope close to zero, clamp down on
jitter

newAltData = ( ((2−n/sp) * (a+(n/sp)*m) + (n/sp)*newRawData)/2 );

}
else
{

| | |
|---|---|
| if ( abs(m−m1) > accel ) { | // if change in speed high |

enough,
// stick closer to raw values

if ( c <= newRawData && newRawData <= d ) {

// new data is within allowable window
newAltData = ( ((a + m) +
(weight+1)*newRawData)/(weight+2) );

}
else if ( newRawData > d || newRawData < c ) {

// new data is outside of allowable window
newAltData = ( a + m + (weight+2)*(newRawData − a −
m)/(weight+3) );

| } | |
|---|---|
| else { | // if speed relatively constant, |

// normal sticking to raw values

newAltData = ( ((a + m) +
(weight)*newRawData)/(weight+1) );

}

}

}
rawData[0] = newRawData;
altData[0] = newAltData;

What is claimed is:

1. An image capturing system comprising:
a scene camera viewing a first image within a defined space;
a tracking marker pattern, including a plurality of tracking markers with identifying indicia, said tracking marker pattern positioned proximate said defined space, but positioned outside a view of said scene camera;
a tracking camera, coupled to said scene camera, said tracking camera oriented to view at least a portion of said tracking marker pattern; wherein said tracking camera captures a view of at least one of said tracking markers; and
a processor in communication said tracking camera, said processor receiving said captured view of at least one of said tracking markers from said tracking camera, said processor processing said captured view to determine a coordinate position of said scene camera, by identifying in said captured view at least one of said tracking markers by said identifying indicia, and determining said coordinate position of said scene camera relative to said at least one identified tracking marker.

2. The image capturing system of claim 1 wherein only one of said tracking markers in said captured view is used to determine said coordinate position of said scene camera.

3. The image capturing system of claim 1 wherein said plurality of tracking markers in said tracking marker pattern are staggered in relation to each other.

4. The image capturing system of claim 1 wherein said processor applies filtering algorithms to said captured view of at least one of said tracking markers.

5. The image capturing system of claim 4 wherein said processor applies different filtering algorithms when it is determined that said scene camera is in motion.

6. The image capturing system of claim 4 wherein said processor applies an aggressive filtering algorithm when it is determined that said scene camera is stationary.

7. The image capturing system of claim 6 wherein said processor applies a less aggressive filtering algorithm when it is determined that said scene camera is in motion.

8. The image capturing system of claim 7 wherein said processor applies an even less aggressive filtering algorithm when it is determined that said scene camera is accelerating.

9. The image capturing system of claim 1 wherein said tracking camera captures a lower quality image than said scene camera.

10. The image capturing system of claim 1 further including:
an orientation sensor, coupled to said scene camera, said orientation sensor to determine an orientation of said scene camera; wherein said orientation sensor is in communication with said processor, to provide orientation data to said processor.

11. A method of tracking a position of a scene camera, said method comprising:
attaching a tracking camera to said scene camera, said tracking camera oriented to view at least a portion a tracking marker pattern, said tracking marker pattern including a plurality of tracking markers with identifying indicia;
capturing an image of at least one of said tracking markers with said tracking camera; and
processing said captured image to identify said at least one tracking marker by said identifying indicia; and to determine a coordinate position of said scene camera relative to said at least one identified tracking marker.

12. The method of claim 11 wherein said step of processing said captured image to determine a coordinate position of said scene camera relative to said at least one identified tracking marker only requires one identified tracking marker.

13. The method of claim 11 wherein said plurality of tracking markers in said tracking marker pattern are staggered in relation to each other.

14. The method of claim 11 wherein said step of processing said captured image to determine a coordinate position of said scene camera relative to at least one identified tracking marker includes applying filtering algorithms to said captured image.

15. The method of claim 14 wherein said step of applying filtering algorithms to said captured image includes applying different filtering algorithms upon determining that said scene camera is in motion.

16. The method of claim 14 wherein said step of applying filtering algorithms to said captured image includes applying an aggressive filtering algorithm upon determining that said scene camera is stationary.

17. The method of claim 16 wherein said step of applying filtering algorithms to said captured image includes applying a less aggressive filtering algorithm upon determining that said scene camera is in motion.

18. The method of claim 17 wherein said step of applying filtering algorithms to said captured image includes applying an even less aggressive filtering algorithm upon determining that said scene camera is accelerating.

19. The method of claim 11 further including:
attaching an orientation sensor to said scene camera; and
processing orientation data from said orientation sensor to determine an orientation of said scene camera.

20. An image capturing system comprising:
a scene camera viewing a first image within a defined space;
a tracking marker pattern, including a plurality of tracking markers with identifying indicia, said tracking marker pattern positioned proximate said defined space, but positioned outside a view of said scene camera;
a tracking camera, coupled to said scene camera, said tracking camera oriented to view at least a portion of said tracking marker pattern; wherein said tracking camera captures a view of at least one of said tracking markers; and
a processor in communication said tracking camera, said processor receiving said captured view of at least one of said tracking markers from said tracking camera, said processor processing said captured view to determine a coordinate position of said scene camera, by identifying in said captured view at least one of said tracking markers by said identifying indicia, and determining said coordinate position of said scene camera relative to said at least one identified tracking marker;
wherein said processor applies filtering algorithms to said captured view of at least one of said tracking markers from said tracking camera; said filtering algorithms dynamically changing based on whether said scene camera is stationary, in motion, or accelerating.
